(19) United States
(12) Patent Application Publication
(10) Pub. No.: US 2018/0261992 A1
(43) Pub. Date: Sep. 13, 2018

(54) SYSTEMS AND METHODS FOR INTEGRATING A BUSBAR AND COLDPLATE FOR BATTERY COOLING

(71) Applicant: Paragon Space Development Corporation, Tucson, AZ (US)

(72) Inventors: Chad E. Bower, Littleton, CO (US); Thomas Cognata, Tucson, AZ (US); Brian F. Richardson, Tucson, AZ (US)

(21) Appl. No.: 15/913,439

(22) Filed: Mar. 6, 2018

Related U.S. Application Data
(60) Provisional application No. 62/468,872, filed on Mar. 8, 2017.

(51) Int. Cl. H02G 5/10; H01M 2/20; H01B 3/30

(52) U.S. Cl. CPC H02G 5/10; H01M 2200/10; H01B 3/306; H01M 2/202

(57) ABSTRACT

This disclosure provides an integrated busbar and coldplate system, where the busbar is configured to provide electrical interconnection between adjacent batteries in a battery module, and the coldplate is configured to remove heat from the busbar and is disposed over a major surface of the busbar. An electrically insulating layer is between the coldplate and the busbar, where the electrically insulating layer is thermally conducting and electrically isolates the busbar from the coldplate.

### PRIORITY CLAIM

This application claims the benefit of priority to U.S. Provisional Patent Application No. 62/468,872, filed Mar. 8, 2017 and entitled “SYSTEMS AND METHODS FOR INTEGRATING A BUSBAR AND COLDPLATE FOR BATTERY COOLING,” which is hereby incorporated by reference in its entirety and for all purposes.

### STATEMENT REGARDING FEDERALLY SPONSORED RESEARCH OR DEVELOPMENT

Some embodiments of this invention were made with United States Government Support under Contract No. N00024-16-P-4500 awarded by the Naval Sea Systems Command. The U.S. Government has certain rights in this invention.

### TECHNICAL FIELD

This disclosure relates to systems and methods for battery cooling, and more particularly to systems, apparatuses, devices, and methods for integrating a busbar to a low-profile, mini-channel coldplate for battery cooling.

### BACKGROUND

Battery temperature greatly affects the performance, safety, and lifetime of batteries. Many industries are paying attention to improvements in thermal management of batteries. More and more industries, such as electric vehicles and other consumer products, are utilizing high-performance energy storage systems with increasing energy density. Some high-performance energy storage systems include battery modules or battery packs having a plurality of batteries with tight space requirements. Some of these high-performance energy storage systems may require high energy density, which require large amounts of energy across short bursts of time. These energy storage systems can generate considerable heat leading to high temperatures that are detrimental to battery cell life and that can cause catastrophic failure.

### SUMMARY

The systems, methods and devices of this disclosure each have several innovative aspects, no single one of which is solely responsible for the desirable attributes disclosed herein.

One innovative aspect of the subject matter described in this disclosure can be implemented in an integrated busbar and coldplate system. The system includes a busbar configured to electrically connect adjacent batteries of a plurality of batteries of a battery module, each battery having a first terminal of a first polarity and a second terminal of a second polarity. The system further includes a coldplate disposed over a major surface of the busbar where the coldplate is configured to remove heat from the busbar, and an electrically insulating layer between and in contact with the busbar and the coldplate, where the electrically insulating layer is thermally conducting and electrically isolates the busbar from the coldplate.

In some implementations, a total thickness of the integrated busbar and coldplate system is equal to or less than a thickness of a baseline busbar for the battery of the battery module. In some implementations, a total thickness of the integrated busbar and coldplate system is between about 0.1 inches and about 0.4 inches. In some implementations, a surface area of the busbar is greater than a surface area of a baseline busbar for the plurality of batteries of the battery module. In some implementations, the electrically insulating layer includes a polyimide film. In some implementations, one or more flow channels are defined in an interior of the coldplate, the one or more flow channels configured to flow cooling fluid through the interior of the coldplate. In some implementations, the coldplate disposed over the busbar covers at least about 50% to about 100% of the surface area of the major surface of the busbar. In some implementations, a heat load discharged per battery from the battery module is between about 15 W and about 300 W, and the batteries of the battery module are capable of a current charge/discharge of greater than about 400 A. In some implementations, a material of the electrically insulating layer has an electrical resistivity greater than about 1.0×10⁷ Ω-m. The material of the electrically insulating layer may have a thermal conductivity greater than about 0.1 W/m-K.

Another innovative aspect of the subject matter described in this disclosure can be implemented in a method of manufacturing an integrated busbar and coldplate system. The method includes connecting a busbar to a terminal of each battery of a plurality of batteries in a battery module, the busbar electrically connecting adjacent batteries of the battery module. The method further includes connecting a coldplate on a major surface of the busbar by using an electrically insulating layer between and in contact with the busbar and the coldplate, where the electrically insulating layer is thermally conducting and electrically isolates the busbar from the coldplate, and where the coldplate is configured to remove heat from the busbar

In some implementations, the method further includes forming a coldplate with one or more flow channels configured to transport cooling fluid through the coldplate. In some implementations, forming the coldplate includes forming the coldplate using direct metal laser sintering, stamping and bonding, three-dimensional (3-D) printing, die-casting or casting, lamination, chemical etching, or traditional machining. In some implementations, connecting the coldplate to the major surface of the busbar includes laminating the coldplate to the major surface of the busbar.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a perspective view of an example battery module including a plurality of batteries and a plurality of busbars for electrically connecting adjacent batteries.

FIG. 2A shows a side view of an example apparatus including a battery module with a plurality of batteries and one or more busbars for electrically connecting adjacent batteries, and further including a coldplate over a major surface of each of the busbars according to some implementations.

FIG. 2B shows a top view of the apparatus of FIG. 2A including the coldplate over each of the busbars according to some implementations.

FIG. 3A shows a cross-sectional perspective view of an example apparatus including a coldplate integrated over at least one busbar, where the at least one busbar electrically connects adjacent batteries of a battery module according to some implementations.

FIG. 3B shows a cross-sectional side view of the apparatus of FIG. 3A including a coldplate integrated over at least one busbar, where the at least one busbar electrically connects adjacent batteries of the battery module according to some implementations.

FIG. 4 shows a cross-sectional schematic of an example apparatus including a coldplate over a busbar, and further including an electrically insulating layer between and in contact with the busbar and the coldplate according to some implementations.

FIG. 5A shows a perspective view of an example coldplate configured to be attached to a busbar of a battery module according to some implementations.

FIG. 5B shows a cross-sectional side view of the coldplate of FIG. 5A according to some implementations.

FIG. 6 shows a perspective view of an example battery module including a plurality of batteries having positive/negative terminals on opposite ends, with busbars and coldplates disposed over the busbars on the opposite ends of the plurality of batteries according to some implementations.

FIG. 7 shows a flow diagram illustrating an example method of manufacturing an integrated busbar and coldplate system according to some implementations.

Like reference numbers and designations in the various drawings indicate like elements.

### DETAILED DESCRIPTION

### Introduction

Heat may be rejected from high energy density systems by a variety of methods. One approach to battery cooling achieves heat-spreading with coldplates. A coldplate may have excellent thermal conductivity and may be liquid-cooled to take away heat that is transferred to the coldplate. The coldplate may be applied to heat-producing parts of the energy storage system, where the coldplate may be large to spread the heat out for removal of the heat. For example, the coldplate may spread the heat from the outer diameter or the base of a battery. However, such an approach may be heavy, costly, and take up a fairly large volume in an energy storage system. Another approach to battery cooling uses air-cooling. For example, a large air flow may be delivered through an energy storage system, where the large air flow may cool the outer diameter or the base of a battery. However, such an approach may require a large air flow rate, may not provide sufficient cooling capacity, and may introduce noise and vibration problems in the battery cooling system.

In typical approaches to battery cooling, heat rejection may be drawn from the outer diameter or base of a battery of a battery module. Such battery cooling approaches are inefficient because they tend to draw heat from an electrically insulating layer, which are typically thermally insulating as well. Cooling from the terminals of a battery is generally avoided because of the potential to short-circuit a system. Moreover, coldplates applied in typical battery cooling applications are potentially very large and increase the mass and volume of the battery package.

### Integrated Coldplate and Busbar

The present disclosure relates to an integrated busbar and coldplate for battery cooling. The present disclosure can acquire high flux heat loads for heat rejection from energy storage systems by drawing heat from inside the battery. For example, the heat can be drawn from electrically and thermally conductive electrodes or terminals of the battery rather than through electrically insulating (and thermally insulating) parts of the battery. Rejection of heat from the electrodes or terminals of the battery improves the performance, safety, and lifetime of the battery. The present disclosure can be applied in energy storage systems with tight space requirements, where the coldplate has a low-profile and is disposed over a busbar of a battery module without increasing the volume of a battery module. In some implementations, the coldplate can optimize battery cooling by maximizing heat transfer while minimizing pressure drop across the coldplate.

Battery cells, such as lithium ion battery cells, metal hydride battery cells, lithium polymer battery cells, or other chemical energy storage cells, are becoming of increased importance in a number of industries. Most battery cells, however, provide low voltages of between one volt and several tens of volts, and most battery cells only provide an electric charge of between 1 and 5 ampere-hours (Ah), which is not sufficient for many applications. As such, battery cells can be connected together to form a battery pack assembly or battery module. In some implementations, a plurality of battery cells are connected to one another in series, so that the output voltage of the battery pack assembly or battery module is multiplied according to the number of battery cells connected in series. In some implementations, the plurality of battery cells are connected to one another in parallel. In the construction of a typical battery pack assembly or battery module, the terminals of battery cells are interconnected by electrically conductive busbars.

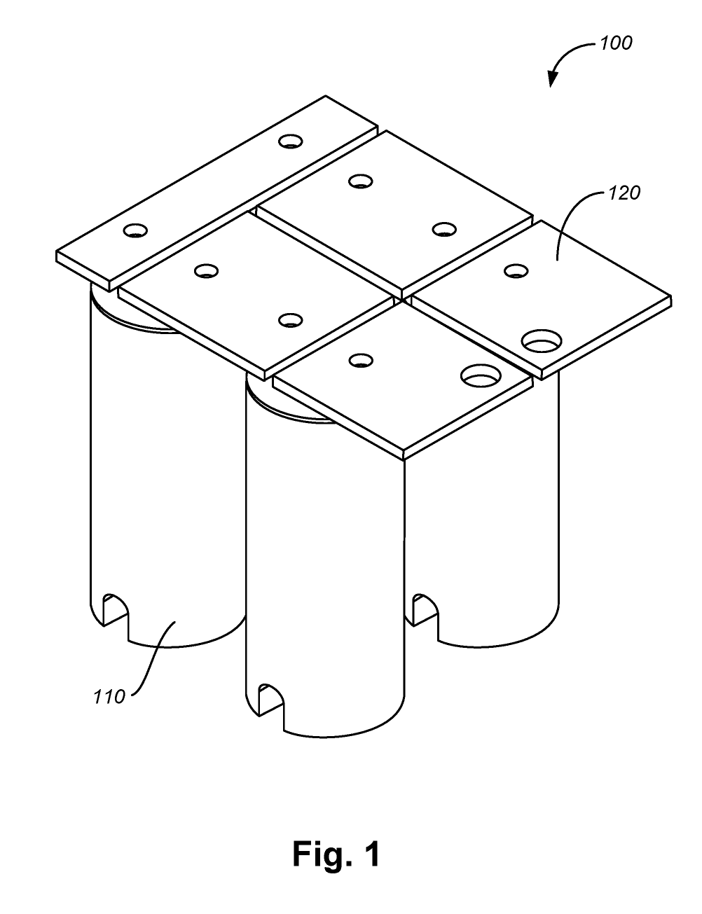

FIG. 1 shows a perspective view of an example battery module including a plurality of batteries and a plurality of busbars for electrically connecting adjacent batteries. A battery module 100 includes a plurality of batteries 110, each battery 110 having a first terminal of a first polarity and a second terminal of a second polarity. For example, the first terminal may correspond to a positive terminal and the second terminal may correspond to a negative terminal, or vice versa. Though the batteries 110 shown in FIG. 1 are cylindrical in shape with terminals on the same end, it will be understood that the batteries 110 may include batteries of any shape, including prismatic or pouch cell batteries, and may include batteries of any topology, including having terminals on opposite ends.

In some implementations, the first terminals of the plurality of batteries 110 are coplanar or at least substantially coplanar. In some implementations, the second terminals of the plurality of batteries 110 are coplanar or at least substantially coplanar. Each battery 110 may have a first end and a second end opposite the first end. In some implementations, the second terminal and the first terminal of each battery 110 are located on the same end of the battery 110.

Busbars 120 provide electrical interconnection between adjacent batteries in a battery module 100. To couple batteries 110 together (e.g., in series or in parallel), an electrical path may be established by coupling the terminals via a busbar 120. The batteries 110 are arranged adjacent to one another, and busbars 120 are positioned to electrically connect adjacent batteries 110. Busbars 120 may be assembled to connect the batteries 110 in parallel and/or in series with each other. In FIG. 1, the busbars 120 are assembled over the first ends of the plurality of batteries 110. However, it will be understood that busbars 120 may be assembled over the second ends of the plurality of batteries 110 or over both the first ends and the second ends of the plurality of batteries 110. As such, in some implementations, the busbars 120 are coplanar or at least substantially coplanar with each other. Each busbar 120 can include an electrically conductive strip connecting adjacent batteries 110 so that each busbar 120 may span between at least two batteries 110. The busbars 120 may include any suitable electrically conductive material, such as copper or copper alloy.

A material composition and a cross-sectional size of the busbar 120 may determine the amount of current that can be safely carried in the busbar 120. A more electrically conductive material and a larger cross-sectional size may permit more electrical current to be carried in the busbar 120. The cross-sectional dimensions of the busbar 120 may be based at least in part on the current draw of a battery 110 of the battery module 100, where such dimensions of the busbar 120 may be referred to as a “baseline” busbar size. The “baseline” busbar can be engineered or otherwise formed knowing an ampere capacity (i.e., ampacity), which is the maximum amount of electric current a conductor can carry before sustaining immediate or progressive deterioration of itself or its surroundings. Thus, depending on the maximum current draw of the battery 110 of the battery module 100, the “baseline” busbar size may be determined. By way of an example, copper busbars may be sized according to the required ampacity as shown in the table in “Ampacities and Mechanical Properties of Rectangular Copper Busbars,” http://www.copper.org/applications/electrical/bubar/bus_table3.html. According to the aforementioned table, where the maximum current draw of a battery 110 is at least 500 A, the busbar 120 may be 0.375 inches thick and 1.0 inches wide. In some implementations, the busbar 120 may be between about 0.1 inches and about 0.5 inches thick and between about 0.25 inches and about 5.0 inches wide. The busbar 120 width and thickness may contribute to the heat spreading function in addition to carrying electrical current.

Each of the batteries 110 in the battery module 100 may generate heat in the body of the batteries 110 and in the terminals and terminal connections of the batteries 110. The battery module 100 may be configured for high current applications, where heat generated in the battery module 100 leads to temperature rises that may be equal to or greater than about 30° C., equal to or greater than about 35° C., equal to or greater than about 40° C., or equal to or greater than about 50° C. Some of the heat may be generated in the body (e.g., “jellyroll”) of the battery 110 and some of the heat may be generated in the terminals and terminal connections of the battery 110. By way of an example, the batteries 110 of the battery module 100 may include Saft VL30P Fe cells that operate at 30 ampere-hours (Ah), where the heat load per battery 110 may be estimated to be between about 15 W and about 100 W.

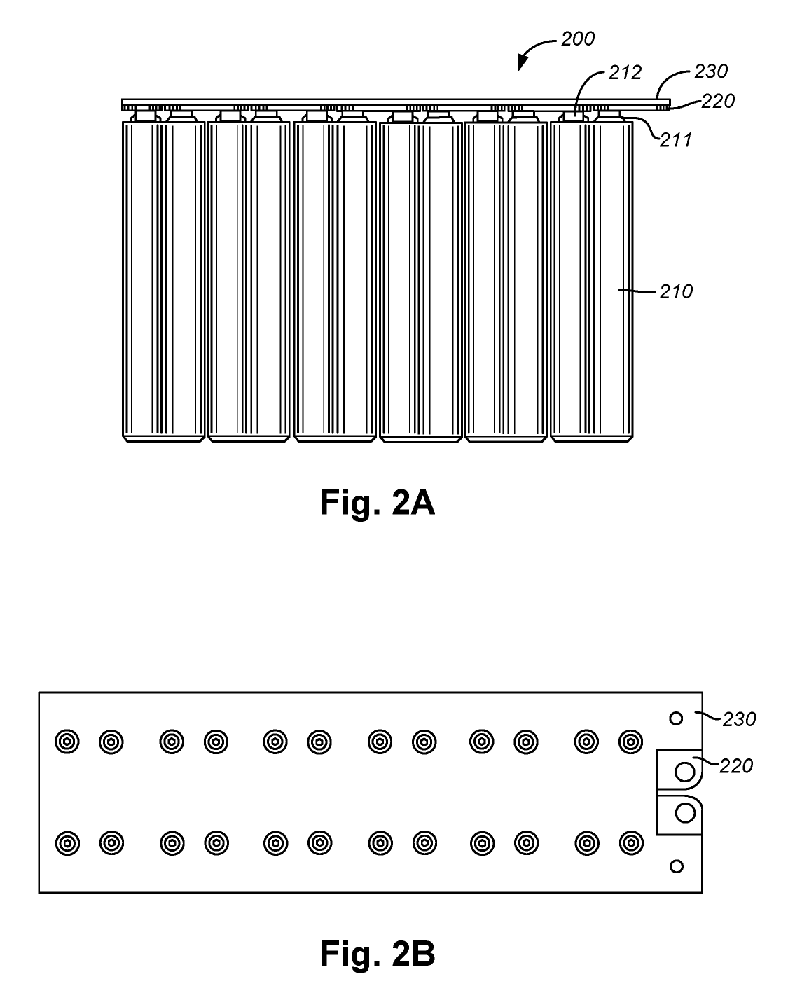

FIG. 2A shows a side view of an example apparatus including a battery module with a plurality of batteries and one or more busbars for electrically connecting adjacent batteries, and further including a coldplate over a major surface of each of the busbars according to some implementations. FIG. 2B shows a top view of the apparatus of FIG. 2A including the coldplate over each of the busbars according to some implementations.

An apparatus 200 includes a battery module, where the battery module includes a plurality of batteries 210 and one or more busbars 220 for providing electrical interconnection between adjacent batteries 210. Each of the batteries 210 can include a first terminal 211 having a first polarity and a second terminal 212 having a second polarity. In some implementations as shown in FIG. 2A, each busbar 220 may electrically connect a first terminal 211 of a first battery and a second terminal 212 of a second battery (i.e., adjacent battery), with the terminals 211, 212 being on the same end of each battery. However, it will be understood that in some implementations, each busbar 220 may electrically connect adjacent batteries 210 where terminals are on opposite ends of each battery.

The apparatus 200 further includes a coldplate 230 on a top surface of the one or more busbars 220, where the top surface is the major surface of each busbar 220 facing away from the terminals 211, 212. Rather than positioning the coldplate 230 on a body or outer diameter of a battery 210, the coldplate 230 may be positioned on the one or more busbars 220 of the battery module. The coldplate 230 may be disposed over the one or more busbars 220 of the battery module, where being “disposed over” refers to being formed, positioned, or otherwise placed in relation to the one or more busbars 220 such that the one or more busbars 220 are between the batteries 210 and the coldplate 230. The coldplate 230 may be in contact with the busbars 220 or at least in thermal engagement with the busbars 220 so that heat may be transferred from the busbars 220 to the coldplate 230. Heat generated in the batteries 210 may be transferred to the one or more busbars 220 via the terminals 211, 212, and at least some of the heat may be transferred from the one or more busbars 220 to the coldplate 230. That way, heat from the terminals 211, 212 of the batteries 210 may be received and rejected via the coldplate 230. The coldplate 230 is integrated with the one or more busbars 220 to form an integrated busbar and coldplate system. An electrically insulating layer (not shown) may be positioned between the one or more busbars 220 and the coldplate 230 that facilitates thermal conduction between the one or more busbars 220 and the coldplate 230.

The coldplate 230 may be in thermal engagement with the one or more busbars 220 to optimize heat exchanging capabilities. The coldplate 230 may cover or at least partially cover the major surface of the one or more busbars 220. In some implementations, the coldplate 230 may cover between about 25% and about 100% of the surface area of the major surface of the one or more busbars 220, or between about 50% and about 100% of the surface area of the major surface of the one or more busbars 220. As shown in FIG. 2B, for example, the coldplate 230 may cover greater than about 80% or greater than about 90% of the surface area of the major surface of the one or more busbars 220. As the one or more busbars 220 serve to spread heat generated from the terminals 211, 212 of the batteries 210, the coldplate 230 in thermal engagement with the one or more busbars 220 may receive and reject the heat that is spread by the one or more busbars 220. Where the one or more busbars 220 have a larger surface area than a baseline busbar to provide greater heat spreading, then greater contact between the coldplate 230 and the one or more busbars 220 can provide greater heat rejection. The coldplate 230 may include any suitable thermally conducting material, such as but not limited to copper, copper alloy, aluminum, aluminum alloy, stainless steel, Inconel, titanium, plastic, etc. For example, the coldplate 230 may include a material with high electrical conductivity and high thermal conductivity, such as aluminum.

Though the apparatus 200 in FIGS. 2A and 2B shows batteries 210 having a cylindrical shape with terminals 211, 212 on the same end, it will be understood that the coldplate 230 may be over the major surface of busbars 220 for batteries 210 having any suitable battery geometry/topology, having any suitable battery module sizes (e.g., 48 V, 24 V, 12 V, etc.), having parallel and/or serial connections, etc.

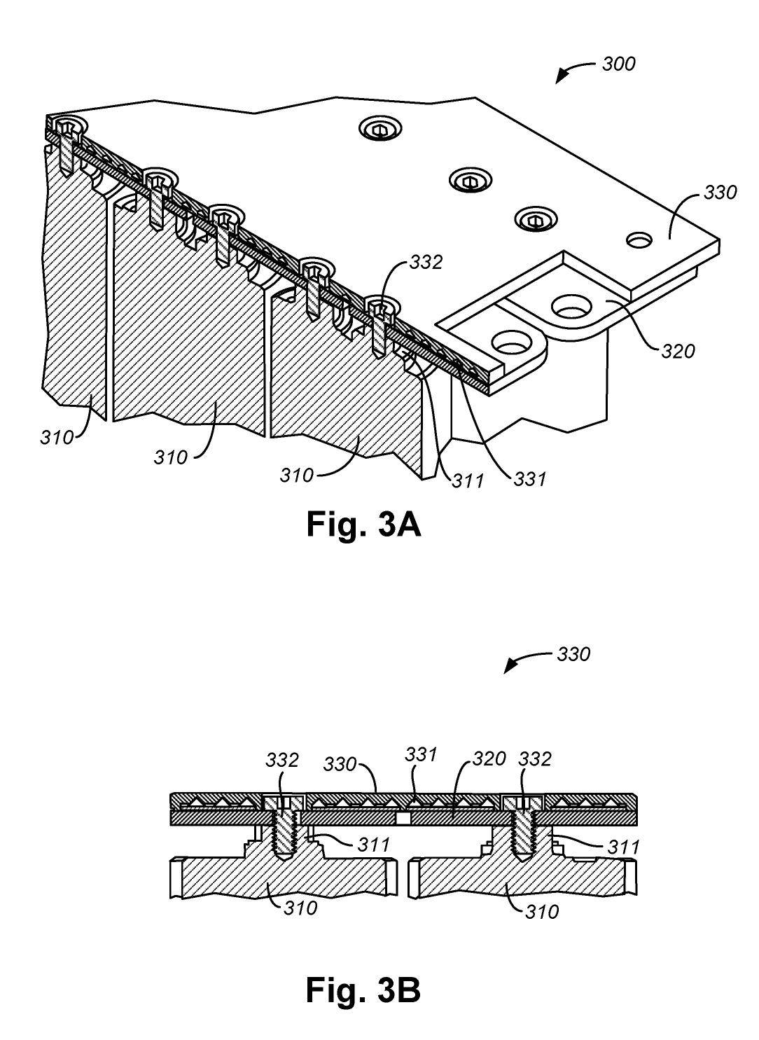

FIG. 3A shows a cross-sectional perspective view of an example apparatus including a coldplate integrated over at least one busbar, where the at least one busbar electrically connects adjacent batteries of a battery module according to some implementations. FIG. 3B shows a cross-sectional side view of the apparatus of FIG. 3A including a coldplate integrated over at least one busbar, where the at least one busbar electrically connects adjacent batteries of the battery module according to some implementations.

An apparatus 300 includes a coldplate 330 on at least one busbar 320, where the busbar 320 is secured or connected with the coldplate 330 to form an integrated busbar 320 and coldplate 330 system. The coldplate 330 can be secured or connected to the busbar 320 via one or more fastening elements 332. In some implementations, the one or more fastening elements 332 may securely fasten the at least one busbar 320 to terminals 311 of batteries 310. Furthermore, one or more fastening elements 332 may compress against a top surface of the at least one busbar 320. In some implementations, the one or more fastening elements 332 do not necessarily contact the coldplate 330. The one or more fastening elements 332 may extend through one or more wells provided through the coldplate 330 without directly contacting the coldplate 330. In some implementations, the one or more wells of the coldplate 330 may include electrically insulating material or the heads of the one or more fastening elements 332 may include electrically insulating material. This can prevent arcing during assembly or during operation of the apparatus 300.

As shown in FIGS. 3A and 3B, one or more flow channels 331 may be defined in the interior of the coldplate 330, where the one or more flow channels 331 are configured to flow cooling fluid through the interior of the coldplate 330. The cooling fluid passes through the one or more flow channels 331 of the coldplate 330 to transport heat away with a relatively high heat transfer coefficient. In some implementations, the cooling fluid includes a single phase working fluid, such as propylene glycol, ethylene glycol, water, and water mixtures of these or fluids, or any other suitable working fluid. For example, a single phase working fluid can include 50/50 propylene glycol/water (PGW). In some implementations, the cooling fluid includes a two-phase working fluid such as a commercially available refrigerant. For example, a two-phase working fluid can include Galden® HT55. Such a fluid can offer low viscosity, excellent electrical resistivity, excellent thermal and chemical stability, broad material compatibility, and no flash or fire points. The cooling fluid may circulate through the interior of the coldplate 330 via the one or more flow channels 331 to transport heat away.

In some implementations, the geometry of the one or more flow channels 331 provides for increased flow distribution and increased strength pressure containment. For example, the one or more flow channels 331 can include internal structures (e.g., pin fins) shaped like inverted pyramids or inverted cones. Accordingly, the one or more flow channels 331 may have a triangular geometry. Though the one or more flow channels 331 in FIGS. 3A and 3B show a triangular geometry, it will be understood that the one or more flow channels 331 may have any suitable geometry, such as an arch-like or semi-circular geometry.

The internal structures defined by the one or more flow channels 331 may connect from a bottom of the coldplate 330 to a top of the coldplate 330. The internal structures may provide mechanical strength and resistance against loading. In some implementations, the pin fins or other internal structures may contribute to the thermal transfer of the coldplate 330. In some implementations, the pin fins or other internal structures may provide stabilization for walls in the coldplate 330 during formation of the coldplate 330. Forming the coldplate 330 includes forming the coldplate using direct metal laser sintering (DMLS), stamping and bonding, three-dimensional (3-D) printing, die-casting or casting, lamination, chemical etching, traditional machining, or any other suitable manufacturing process. In some implementations, the coldplate 330 may be prototyped using a rapid prototyping process such as 3-D printing, and may be produced at large quantities using an appropriate low-cost high-volume manufacturing process. The rapid prototyping process and the appropriate low-cost high-volume manufacturing process may produce the same coldplate 330 having identical or similar functions.

The integrated busbar 320 and coldplate 330 system can have an overall thickness that is reduced to provide for a low-profile system. In particular, an overall thickness of the integrated busbar 320 and coldplate 330 system can be equal to or less than a baseline busbar thickness of the battery module. This can be accomplished by having a relatively thin coldplate 330 and a thinner busbar 320 than the baseline busbar thickness of the battery module. In some implementations, an overall thickness of the integrated busbar and coldplate system is between about 0.1 inches and about 0.4 inches.

The coldplate 330 can have a thickness that is relatively small and designed with a low profile. The coldplate 330 can be designed with a low profile by having wide flow channels 331 combined with a small height. That way, even with a small height, the pressure drop is minimized across the coldplate 330 and heat transfer is maximized when the channel width is open for cooling fluid to flow through. A decreased pressure drop may correspond to an increased heat transfer across the coldplate 330.

The busbar 320 can have a thickness less than a baseline busbar thickness of the battery module. A baseline busbar is ordinarily sized according to the electrical requirements of the batteries 310 of the battery module. For example, a baseline busbar can have a length, width, and height (i.e., thickness) that accommodates a current draw profile of the battery 310. In some implementations, the batteries 310 of the battery module are capable of a current charge/discharge of greater than about 300 A, greater than about 400 A, greater than about 450 A, or greater than about 500 A. In some implementations, a heat load discharged per battery 310 from the battery module is between about 15 W and about 300 W. For example, the heat load discharged per battery 310 from the battery module is about 200 W.

However, the busbar 320 of the present disclosure can be sized so as to reduce its thickness relative to the baseline busbar of the battery module, but increase one or both of its major dimensions (e.g., length and/or width) relative to the baseline busbar of the battery module. Without necessarily decreasing the electrical conduction properties of the busbar 320, the busbar 320 can be thinner but wider to facilitate increased heat transfer to the coldplate 330. The surface area of the busbar 320 may be greater than a surface area of a baseline busbar of the battery 310. This makes improved use of the surface area of the busbar 320 for heat transfer performance. The electrical current carrying capacity of the busbar 320 is not necessarily decreased. However, it will be understood that the surface area of the busbar 320 need not be necessarily greater than the surface area of the baseline busbar of the battery 310 as long as the surface area of the busbar 320 effectively spreads out heat generated from the battery 310 for removal of the heat.

Integration of the coldplate 330 with the busbar 320 does not necessarily increase the profile of the battery module. By way of an example, a baseline busbar thickness can be about 0.375 inches for a battery module, where the batteries 310 of the battery module have a maximum current draw of 500 A. In FIG. 3B, a thickness of the busbar 320 can be about 0.130 inches and a thickness of the coldplate 330 can be about 0.160 inches. Thus, the integrated busbar 320 and coldplate 330 can have a thickness of about 0.290 inches, which is less than the thickness of about 0.375 inches for the baseline busbar in this implementation.

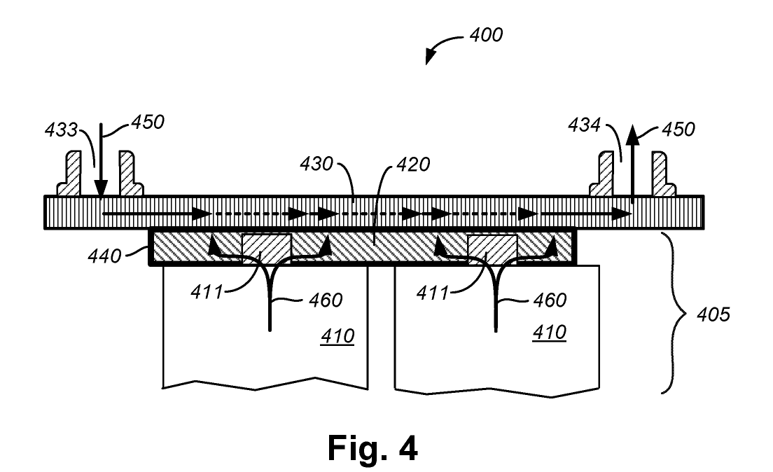

FIG. 4 shows a cross-sectional schematic of an example apparatus including a coldplate over a busbar, and further including an electrically insulating layer between and in contact with the busbar and the coldplate according to some implementations. An apparatus 400 includes a plurality of batteries 410 of a battery module 405, each battery 410 having at least a terminal 411. The apparatus 400 further includes a busbar 420 configured to electrically connect the adjacent batteries 410 of the battery module 405, where the busbar 420 is electrically connected to one of the terminals 411 of each battery 410. The apparatus 400 further includes a coldplate 430 disposed over a major surface of the busbar 420, where the coldplate 430 is configured to remove heat from the busbar 420. The coldplate 430 is integrated with the busbar 420 to form an integrated busbar 420 and coldplate 430 system.

The apparatus 400 further includes an electrically insulating layer 440 between and in contact with the busbar 420 and the coldplate 430, where the electrically insulating layer 440 is both electrically insulating and thermally conducting. Otherwise, placing the coldplate 430 directly in contact with the busbar 420 and passing cooling fluid through the coldplate 430 will electrically short-circuit the busbar 420. The electrically insulating layer 440 serves to electrically isolate the coldplate 430 from the busbar 420. However, the electrically insulating layer 440 also serves to provide thermal conduction between the coldplate 430 and the busbar 420.

In some implementations, the electrically insulating layer 440 includes a polyimide, such as Kapton®. Kapton® is a polyimide that is manufactured by DuPont of Wilmington, Del. It will be understood that the electrically insulating layer 440 includes any suitable dielectric film, where a suitable dielectric film has appropriate thermal properties for through-plane thermal conduction between the coldplate 430 and the busbar 420. In some implementations, the electrically insulating layer 440 includes an adhesive, such as an acrylic adhesive. The adhesive can be positioned on each side of the polyimide to contact both the coldplate 430 and the busbar 420. For example, the adhesive can be a two-sided tape that adheres the coldplate 430 to the electrically insulating layer 440 and the busbar 420 to the electrically insulating layer 440.

The electrically insulating layer 440 can include a material with high electrical resistivity (p). In some implementations, the electrical resistivity of the material can be greater than about 1.0×10³ Ω-m, greater than about 1.0×10⁴ Ω-m, greater than about 1.0×10⁵ Ω-m, greater than about 1.0×10⁶ Ω-m, greater than about 1.0×10⁷ Ω-m, greater than about 1.0×10⁸ Ω-m, greater than about 1.0×10⁹ Ω-m, or greater than about 1.0×10¹⁰ Ω-m at 20° C. For example, some types of Kapton® can have an electrical resistivity as high as about 1.0×10¹⁵ Ω-m at 20° C.

The material of the electrically insulating layer 440 with a high electrical resistivity also can have a relatively high thermal conductivity (K). In some implementations, the thermal conductivity of the material can be greater than about 0.05 W/m-K, greater than about 0.1 W/m-K, greater than about 0.2 W/m-K, or greater than about 0.4 W/m-K. For example, various types of Kapton® can have a thermal conductivity between about 0.46 W/m-K and about 4.3 W/m-K.

A ratio of the electrical conductivity of the material to the thermal conductivity of the material can be referred to as a “figure of merit.” The electrical conductivity can be the reciprocal of electrical resistivity: σ=1/ρ. Thus, the figure of merit can be calculated according to the following formula: α/κ. A lower figure of merit can be indicative of a material with high electrical resistivity and high thermal conductivity, whereas a higher figure of merit can be indicative of a material with one or both of a low electrical resistivity and a low thermal conductivity. For the electrically insulating layer 440, it is desirable to utilize a material with a low figure of merit. In some implementations, the figure of merit for a material of the electrically insulating layer 440 can be greater than about 2.0×10⁻³, greater than about 2.0×10⁻⁴, greater than about 2.0×10⁻⁵, greater than about 2.0×10⁻⁶, greater than about 2.0×10⁻⁷, or greater than about 2.0×10⁻⁸.

The electrically insulating layer 440 can be thick enough to electrically isolate the coldplate 430 from the busbar 420. However, the electrically insulating layer 440 can be thin enough to limit the electrically insulating layer 440 from substantially increasing the profile of the battery module 405. In some implementations, the electrically insulating layer 440 has a thickness between about 0.002 inches and about 0.01 inches, or between about 0.003 inches and about 0.008 inches. For example, the electrically insulating layer 440 has a thickness of about 0.005 inches.

FIG. 4 illustrates heat transfer paths 460 for rejection of heat from the apparatus 400. As shown by the heat transfer paths 460, heat generated in the batteries 410 flows through the terminals 411 and into the busbar 420. The busbar 420 is thermally conductive and spreads the heat evenly over an interface with the coldplate 430. A cooling fluid 450 passing through the coldplate 430 transports the heat away with a high heat transfer coefficient. In some implementations, a higher heat transfer coefficient allows for specified heat removal with reduced temperature rise in fluid temperature relative to wall temperature, and specifically reduced temperature rise from the mixed mean average fluid temperature to wall temperature. The cooling fluid 450 enters the coldplate 430 through an inlet 433 and exits through an outlet 434. Because the coldplate 430 is electrically isolated from the electrically conductive busbar 420 by the electrically insulating layer 440, the electrically insulating layer 440 prevents electrical short circuits between adjacent busbars 420, but allows heat from the busbars 420 to flow to the coldplate 430. The coldplate 430 efficiently removes heat generated from the terminals 411 of the batteries 410 without impeding the operation and performance of the batteries 410.

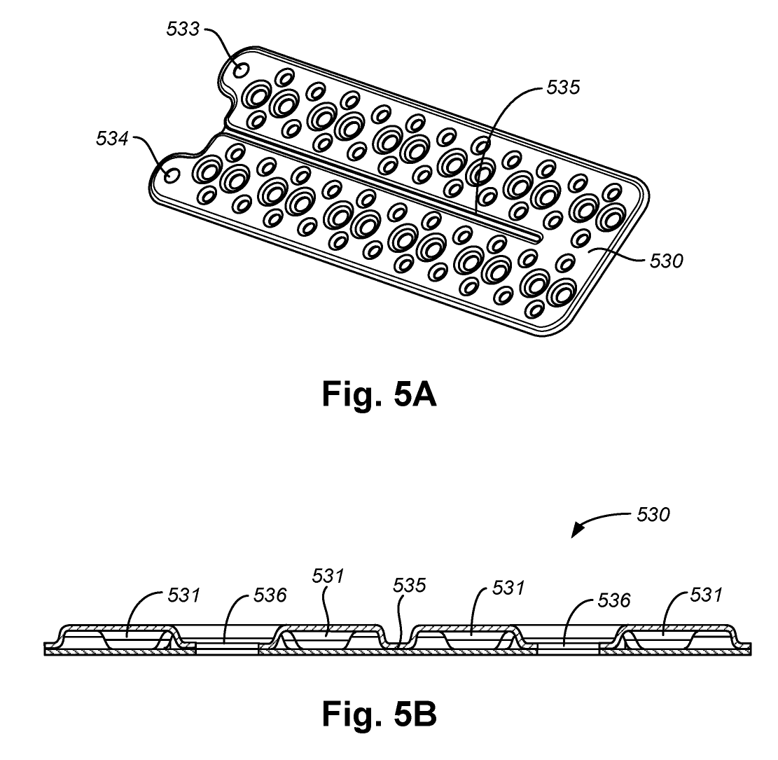

FIG. 5A shows a perspective view of an example coldplate configured to be attached to a busbar of a battery module according to some implementations. FIG. 5B shows a cross-sectional side view of the coldplate of FIG. 5A according to some implementations. A coldplate 530 of the present disclosure can have a low profile and high heat transfer coefficient. One or more flow channels 531 can be defined in the coldplate 530 for transporting cooling fluid through. Though the one or more flow channels 531 in FIG. 5B shows an inverted cone/trapezoid geometry, it will be understood that the one or more flow channels 531 can have any suitable cross-sectional geometry. In some implementations, the coldplate 530 is formed and joined at one or more connection points 536, such as by stamping and bonding. A characteristic dimension or thickness of the one or more flow channels 531 can be inversely proportional to the heat transfer coefficient of the coldplate 530. If the one or more flow channels 531 are thinner, then the pressure drop of the cooling fluid through the coldplate 530 is higher. However, certain design constraints may limit the pressure drop from exceeding a threshold. Increasing a width of the one or more flow channels 531 can reduce the pressure drop of the cooling fluid through the coldplate 530 and reduce pumping power. Thus, the coldplate 530 of the present disclosure can be designed to maximize the heat transfer coefficient with thin flow channels 531, and to minimize the pressure drop of the cooling fluid passing through the coldplate 530 with wide flow channels 531. Such flow channels 531 may be referred to as “mini-channels” or “micro-channels” of the coldplate 530.

In FIG. 5A, the coldplate 530 includes an inlet 533 by which cooling fluid enters the coldplate 530 and an outlet 534 by which the cooling fluid exits the coldplate 530. The coldplate 530 includes a divider 535 that runs along a central portion of the coldplate 530. The cooling fluid flows through the coldplate 530 in a U-shape around the divider 535. Specifically, the cooling fluid enters the inlet 533 at the top-left, wraps around the divider 535 on the right-hand side, and exits the outlet 534 at the bottom-left.

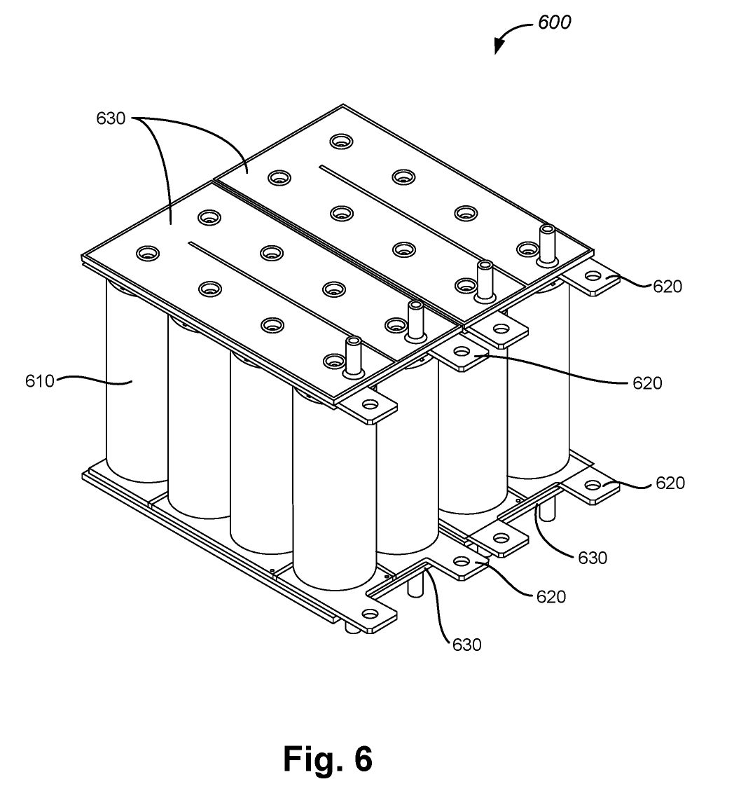

FIG. 6 shows a perspective view of an example battery module including a plurality of batteries having positive/negative terminals on opposite ends, with busbars and coldplates disposed over the busbars on the opposite ends of the plurality of batteries according to some implementations. An apparatus 600 includes a battery module with a plurality of batteries 610. The plurality of batteries 610 may be arranged in the battery module according to a desired module size for a desired output. For example, a number of the batteries 610 may correspond to a desired output, such as outputs of 6V, 12V, 24V, 48V, etc. The plurality of batteries 610 may have a desired geometry, such as cylindrical or prismatic. Prismatic-shaped batteries may include pouch cell batteries or hard case batteries depending on the housing. The plurality of batteries 610 may have a desired topology, such as having the terminals of the batteries 610 positioned on the same end or positioned on opposite ends. In FIG. 6 of the apparatus 600, the plurality of batteries 610 are cylindrical in shape and the terminals of the batteries 610 are positioned on opposite ends.

The apparatus 600 can further include a plurality of busbars 620, where the plurality of busbars 620 electrically connect adjacent batteries 610 in the battery module. The plurality of busbars 620 may connect the plurality of batteries 610 in series, in parallel, or a combination thereof. In some implementations where the plurality of batteries 610 are connected in parallel, the plurality of batteries 610 may have all of its negative terminals electrically connected to a first busbar and all of its positive terminals electrically connected to a second busbar. In some implementations where the plurality of batteries 610 are connected in series, a positive terminal of a first battery may be electrically connected to a negative terminal of a second battery via a busbar 620, and a positive terminal of the second battery may be connected to a negative terminal of a third battery, and so forth. In some implementations where some of the plurality of batteries 610 are connected in parallel and some of the plurality of batteries 610 are connected in series, some positive terminals are electrically connected in parallel to a first busbar and some negative terminals are electrically connected in parallel to a second busbar. The remainder of the positive terminals and negative terminals are electrically connected in series via one or more busbars 620.

The apparatus 600 can further include one or more coldplates 630. Regardless of the topology, geometry, or module size of the plurality of batteries 610, and regardless of whether the busbars 620 provide electrical interconnection between batteries 610 in series or in parallel, one or more coldplates 630 may be disposed over a major surface of the plurality of busbars 620. As shown in FIG. 6, the one or more coldplates 630 may be disposed on both ends of each of the plurality of batteries 610. Accordingly, the batteries 610 of the battery module are sandwiched between coldplates 630 on opposite ends. An electrically insulating layer (not shown) interfaces between each of the one or more coldplates 630 and each of the busbars 620.

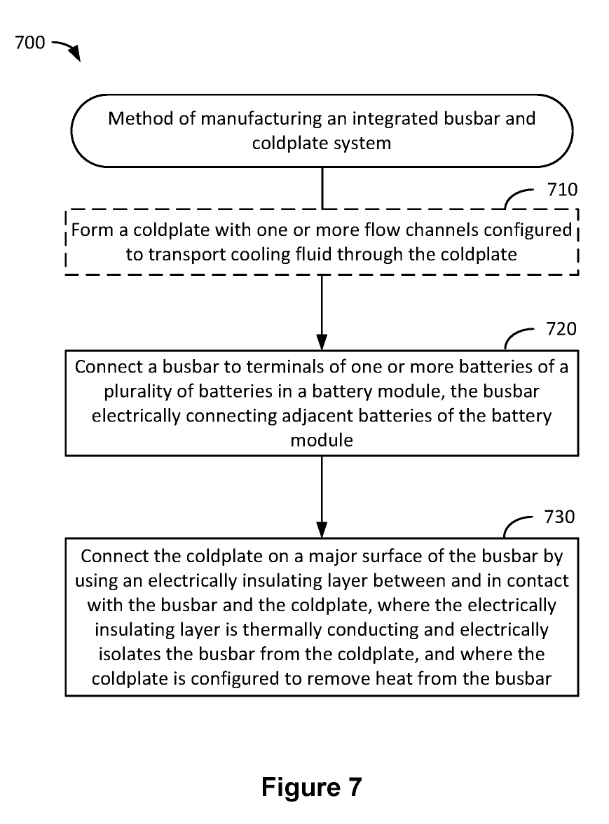

FIG. 7 shows a flow diagram illustrating an example method of manufacturing an integrated busbar and coldplate system according to some implementations. The process 700 may be performed in a different order or with different, fewer, or additional operations.

At block 710 of the process 700, a coldplate is optionally formed with one or more flow channels. The one or more flow channels are configured to transport cooling fluid through the coldplate. The one or more flow channels may have any suitable cross-sectional geometry, where the cross-sectional geometry may minimize a pressure drop of the cooling fluid flowing through the coldplate. For example, the one or more flow channels may have a triangular cross-sectional geometry or an arch-shaped cross-sectional geometry.

In some implementations, forming the coldplate includes using any suitable manufacturing process, such as direct metal laser sintering, stamping and bonding, three-dimensional (3-D) printing, die-casting or casting, lamination, chemical etching, and traditional machining. For example, three-dimensional printing may be employed for rapid prototyping of the coldplate and other manufacturing processes may be employed for low-cost high-volume manufacturing.

At block 720 of the process 700, a busbar is connected to terminals of one or more batteries of a plurality of batteries in a battery module. The busbar electrically connects adjacent batteries of the battery module.

In some implementations, the busbar electrically connects adjacent batteries in series. In some implementations, the busbar electrically connects adjacent batteries in parallel. In some implementations, the plurality of batteries may be cylindrical in shape. In some implementations, the plurality of batteries may be prismatic in shape. In some implementations, each of the plurality of batteries may have terminals on the same end. In some implementations, each of the plurality of batteries may have terminals on opposite ends. The busbar may have a thickness less than a baseline busbar thickness for a specified battery of the battery module. However, a surface area of the major surface of the busbar may be greater than a baseline busbar surface area for the specified battery of the battery module. It will be understood that the surface area of the major surface of the busbar need not necessarily be greater than a major surface of a baseline busbar as long as the major surface of the busbar is configured to effectively spread the heat generated from the battery module for removal of the heat.

At block 730 of the process 700, a coldplate is connected on a major surface of the busbar by using an electrically insulating layer between and in contact with the busbar and the coldplate. The electrically insulating layer is thermally conducting and electrically isolates the busbar from the coldplate. The coldplate is configured to remove heat from the busbar.

The electrically insulating layer interfaces between the coldplate and the busbar. Though the electrically insulating layer is between and in contact with the busbar and the coldplate, it will be understood that additional layers, such as adhesive layers, may be positioned between the electrically insulating layer and the coldplate and between the electrically insulating layer and the busbar. In some implementations, the electrically insulating layer includes a polyimide film, such as Kapton®. However, it will be understood that the electrically insulating layer can include any suitable dielectric film with appropriate thermal properties for through-plane thermal conduction between the coldplate and the busbar. The electrically insulating layer facilitates heat transfer from terminals of the one or more batteries to the coldplate so that heat may be efficiently removed from the battery module.

In some implementations, connecting the coldplate to the major surface of the busbar includes laminating the coldplate to the major surface of the busbar. In some implementations, the coldplate covers between about 50% and about 100% of the surface area of the major surface of the busbar.

Although the foregoing disclosed systems, methods, apparatuses, processes, and compositions have been described in detail within the context of specific implementations for the purpose of promoting clarity and understanding, it will be apparent to one of ordinary skill in the art that there are many alternative ways of implementing foregoing implementations which are within the spirit and scope of this disclosure. Accordingly, the implementations described herein are to be viewed as illustrative of the disclosed inventive concepts rather than restrictively, and are not to be used as an impermissible basis for unduly limiting the scope of any claims eventually directed to the subject matter of this disclosure.

What is claimed is:

1. A system, comprising:
a busbar configured to electrically connect adjacent batteries of a plurality of batteries of a battery module, each battery having a first terminal of a first polarity and a second terminal of a second polarity;
a coldplate disposed over a major surface of the busbar, wherein the coldplate is configured to remove heat from the busbar; and
an electrically insulating layer between and in contact with the busbar and the coldplate, wherein the electrically insulating layer is thermally conducting and electrically isolates the busbar from the coldplate.

2. The system of claim 1, wherein a total thickness of the integrated busbar and coldplate system is equal to or less than a thickness of a baseline busbar for a battery of the battery module.

3. The system of claim 1, wherein a total thickness of the integrated busbar and coldplate system is between about 0.1 inches and about 0.4 inches.

4. The system of claim 1, wherein a surface area of the busbar is greater than a surface area of a baseline busbar for the plurality of batteries of the battery module.

5. The system of claim 1, wherein the system provides heat transfer paths between the busbar and the terminals of the batteries and between the coldplate and the busbar.

6. The system of claim 1, wherein the electrically insulating layer includes a polyimide film.

7. The system of claim 6, wherein the polyimide film includes Kapton®.

8. The system of claim 1, wherein the electrically insulating layer has a thickness between about 0.003 inches and about 0.008 inches.

9. The system of claim 1, wherein one or more flow channels are defined in an interior of the coldplate, the one or more flow channels configured to flow cooling fluid through the interior of the coldplate.

10. The system of claim 9, wherein one or more internal structures in the one or more flow channels connect a top of the coldplate to a bottom of the coldplate.

11. The system of claim 9, wherein the cooling fluid includes a single phase working fluid or a two-phase working fluid.

12. The system of claim 1, wherein the coldplate disposed over the busbar covers at least about 50% to about 100% of a surface area of the major surface of the busbar.

13. The system of claim 1, wherein a heat load discharged per battery from the battery module is between about 15 W and about 300 W, and wherein the batteries of the battery module are capable of a current charge/discharge of greater than about 400 A.

14. The system of claim 1, wherein the busbar electrically connects the first terminal of one of the plurality of batteries to the second terminal of another one of the plurality of batteries.

15. The system of claim 1, wherein the busbar electrically connects first terminals of at least some of the plurality of batteries.

16. The system of claim 1, wherein a material of the electrically insulating layer has an electrical resistivity greater than about 1.0×10⁷ Ω-m.

17. The system of claim 16, wherein the material of the electrically insulating layer has a thermal conductivity greater than about 0.1 W/m-K.

18. A method of manufacturing an integrated busbar and coldplate system, the method comprising:
connecting a busbar to terminals of one or more batteries of a plurality of batteries in a battery module, the busbar electrically connecting adjacent batteries of the battery module; and
connecting a coldplate on a major surface of the busbar by using an electrically insulating layer between and in contact with the busbar and the coldplate, wherein the electrically insulating layer is thermally conducting and electrically isolates the busbar from the coldplate, and wherein the coldplate is configured to remove heat from the busbar.

19. The method of claim 18, further comprising:
forming the coldplate with one or more flow channels configured to transport cooling fluid through the coldplate.

20. The method of claim 19, wherein forming the coldplate includes forming the coldplate using direct metal laser sintering, stamping and bonding, three-dimensional printing, die-casting or casting, lamination, chemical etching, or traditional machining.

21. The method of claim 18, wherein connecting the coldplate to the major surface of the busbar includes laminating the coldplate to the major surface of the busbar.

22. The method of claim 18, wherein the electrically insulating layer includes Kapton®.
